(19) United States
(12) Patent Application Publication
(10) Pub. No.: US 2011/0051027 A1
(43) Pub. Date: Mar. 3, 2011

(54) ARRAY SUBSTRATE FOR LIQUID CRYSTAL DISPLAY DEVICE

(76) Inventors: Chang-Yeop SHIN, Gyeongsangbuk-do (KR); Jeong-Ki Kim, Daegu (KR); Sun-Yong Lee, Daegu (KR)

(21) Appl. No.: 12/871,139

(22) Filed: Aug. 30, 2010

(30) Foreign Application Priority Data
Sep. 2, 2009 (KR) 10-2009-0082669

(51) Int. Cl. G02F 1/136

(52) U.S. Cl. 349/42

(57) ABSTRACT

An array substrate for a liquid crystal display device includes a plurality of gate lines on a substrate; a plurality of data lines crossing the plurality of gate lines to define a plurality of pixel regions; a thin film transistor connected to one of the plurality of gate lines and one of the plurality of data lines and disposed in one pixel region of the plurality of pixel regions; first and second shield patterns respectively extending from a previous gate line of the plurality of gate lines to the one pixel region, the first shield pattern disposed at one side of the one pixel region, and the second shield pattern disposed at the other side of the one pixel region; and a pixel electrode in the one pixel region and over the thin film transistor, the pixel electrode overlapping the first and second shield patterns and the previous gate line.

The present application claims the benefit of Korean Patent Application No. 10-2009-0082669 filed in Korea on Sep. 2, 2009, which is hereby incorporated by reference.

### BACKGROUND OF THE INVENTION

1. Field of the Invention

The present invention relates to a liquid crystal display (LCD) device and more particularly to an arrays substrate having improved aperture ratio and storage capacitance.

2. Discussion of the Related Art

Recently, the LCD devices having characteristics of light weight, thinness and low power consumption are introduced. Among these LCD devices, the LCD device including a thin film transistor (TFT) as a switching element, referred to as an active matrix LCD (AM-LCD) device, has excellent characteristics of high resolution and displaying moving images such that the AM-LCD device are widely used.

Generally, the LCD devices are fabricated by an array substrate process, a color filter substrate process and a cell process. In the array substrate process, a TFT and a pixel electrode are formed on a first substrate such that an array substrate is obtained. In the color filter substrate process, a color filter and a common electrode are formed on a second substrate such that a color filter substrate is obtained. Then, in the cell process, a liquid crystal layer is interposed between the first and second substrates.

FIG. 1 is an exploded perspective view of the related art LCD device. In FIG. 1, The LCD device includes first and second substrates 12 and 22, and a liquid crystal layer 30. The first and second substrates 12 and 22 face each other, and the liquid crystal layer 30 is interposed therebetween.

The first substrate 12 includes a gate line 14, a data line 16, a TFT Tr, and a pixel electrode 18. The first substrate 12 including these elements is referred to as an array substrate 10. The gate line 14 and the data line 16 cross each other such that a region is formed between the gate and data lines 14 and 16 and is defined as a pixel region P. The TFT Tr is formed at a crossing portion of the gate and data lines 14 and 16, and the pixel electrode 18 is formed in the pixel region P and connected to the TFT Tr.

The second substrate 22 includes a black matrix 25, a color filter layer 26, and a common electrode 28. The second substrate 22 including these elements is referred to as a color filter substrate 20. The black matrix 25 has a lattice shape to cover a non-display region of the first substrate 12, such as the gate line 14 and the data line 16 on the first substrate 12. A light leakage in the non-display region is blocked by the black matrix 25. The color filter layer 26 includes first, second, and third sub-color filters 26a, 26b, and 26c. Each of the sub-color filters 26a, 26b, and 26c has one of red, green, and blue colors R, G, and B and corresponds to the each pixel region “P”. The common electrode 28 is formed on the black matrix 25 and the color filter layers 26 and over an entire surface of the second substrate 22.

Although not shown, edges of the first and second substrates 12 and 22 are sealed such that a leakage of the liquid crystal layer 30 is prevented. First and second alignment layers for controlling an initial arrangement of the liquid crystal molecules in the liquid crystal layer 30 are formed on the first and second substrates 12 and 22, respectively. A polarizing plate is formed on at least one outer side of the first and second substrates 12 and 22. In addition, a backlight unit for providing light is disposed under the first substrate 12.

When the TFT “Tr” is turned on by a signal through the gate line 14, a signal is applied to the pixel electrode 18 through the data line 16 such that a vertical electric field is induced between the pixel and common electrode 18 and 28. As a result, the liquid crystal layer 30 is driven by a vertical electric such that the LCD device can produce images.

FIG. 2 is a plane view showing one pixel region of an array substrate for the related art LCD device. In FIG. 2, a gate line 53 and a data line 70 are disposed on a substrate 50. The gate and data lines 53 and 70 cross each other to define a pixel region P.

A TFT Tr, which is connected to the gate and data lines 53 and 70, as a switching element is disposed in the pixel region P. The TFT Tr includes a gate electrode 55, a gate insulating layer (not shown), a semiconductor layer 65, a source electrode 73 and a drain electrode 76. The gate electrode 55 is connected to the gate line 53, and the gate insulating layer is disposed on the gate electrode 55. The semiconductor layer 65 includes an active layer (not shown) and ah ohmic contact layer (not shown). The source electrode 73 is connected to the data line 70 and is spaced apart from the drain electrode 76.

A passivation layer (not shown) covers the TFT Tr. The passivation layer includes a drain contact hole 82 exposing the drain electrode 76. A pixel electrode 85 is disposed in the pixel region P and on the passivation layer. The pixel electrode 85 contacts the drain electrode 76 through the drain contact hole 82. One end of the pixel electrode 85 overlaps the previous gate line 53 to form a storage capacitor StgC.

In the array substrate including the above storage capacitor StgC, there is a limitation in rapid response. Namely, the storage capacitance of the above storage capacitor StgC is insufficient. If an overlapped area of the pixel electrode 85 and the previous gate line 53 is increased to obtain sufficient storage capacitance, there is a disadvantage in aperture ratio.

In addition, to prevent a light leakage through a space between the pixel electrode 85 and the data line 70, a width of the black matrix 25 (of FIG. 1) is increased. Accordingly, aperture ratio of the LCD device is reduced.

### SUMMARY OF THE INVENTION

Accordingly, the present invention is directed to an array substrate for an LCD device that substantially obviates one or more of the problems due to limitations and disadvantages of the related art.

An object of the present invention is to provide an array substrate for an LCD device having improved aperture ratio.

An object of the present invention is to provide an array substrate for an LCD device having sufficient storage capacitance.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described herein, an array substrate for a liquid crystal display device includes a plurality of gate lines on a substrate; a plurality of data lines crossing the plurality of gate lines to define a plurality of pixel regions; a thin film transistor connected to one of the plurality of gate lines and one of the plurality of data lines and disposed in one pixel region of the plurality of pixel regions; first and second shield patterns respectively extending from a previous gate line of the plurality of gate lines to the one pixel region, the first shield pattern disposed at one side of the one pixel region, and the second shield pattern disposed at the other side of the one pixel region; and a pixel electrode in the one pixel region and over the thin film transistor, the pixel electrode overlapping the first and second shield patterns and the previous gate line.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

FIG. 1 is an exploded perspective view of the related art LCD device;

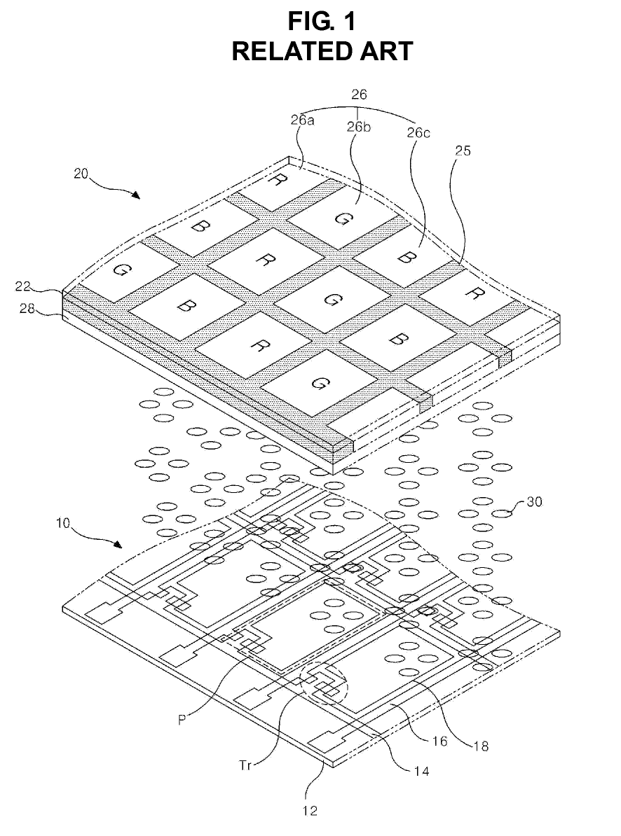

FIG. 2 is a plane view showing one pixel region of an array substrate for the related art LCD device;

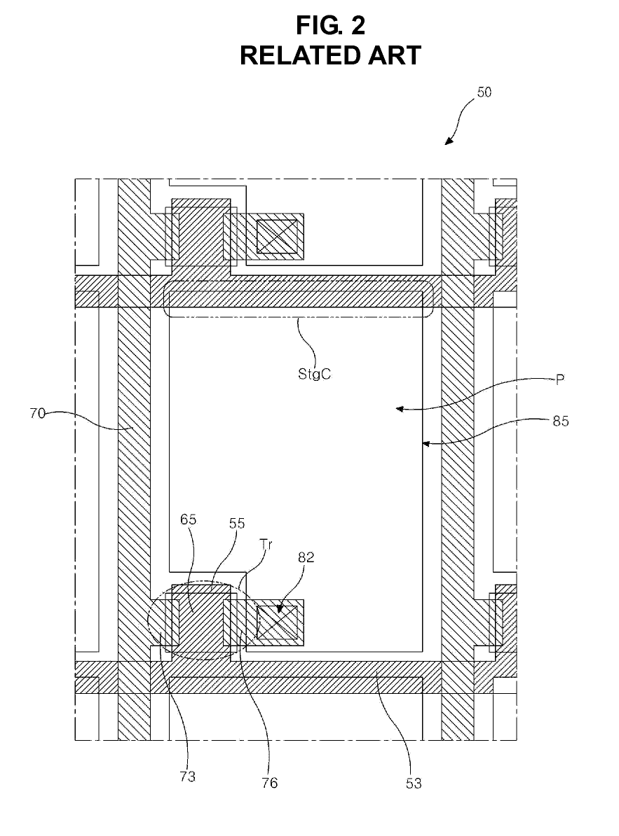

FIG. 3 is a plane view showing one pixel region of an array substrate for an LCD device according to a first embodiment of the present invention; and

FIG. 4 is a plane view showing one pixel region of an array substrate for an LCD device according to a second embodiment of the present invention.

### DETAILED DESCRIPTION OF THE PREFERRED EMBODIMENTS

Reference will now be made in detail to the preferred embodiments, examples of which are illustrated in the accompanying drawings.

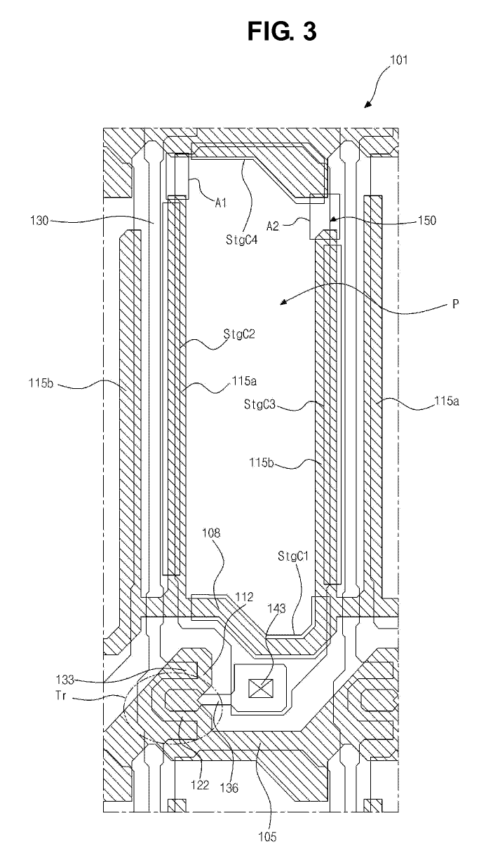

FIG. 3 is a plane view showing one pixel region of an array substrate for an LCD device according to a first embodiment of the present invention.

As shown in FIG. 3, a gate line 105 and a data line 130 are disposed on a substrate 101. The gate and data lines 105 and 130 cross each other to define a pixel region P.

A common line 108 is disposed on the substrate 101 and is spaced apart from the gate line 105. The common line 108 is substantially parallel to the gate line 105. The common line 108 is disposed at the same layer as the gate line 105. In addition, first and second shield patterns 115a and 115b extends from the common line 108. The first shield pattern 115a is disposed at one side of the pixel region P, and the second shield pattern 115b is disposed at the other side of the pixel region P. Each of the first and second shield patterns 115a and 115b is substantially parallel to the data line 130. To avoid an electrical short with the previous gate line, an end of each of the first and second shield patterns 115a and 115b should be sufficiently spaced apart from the previous gate line. Namely, a space A1 between the previous gate line and the first shield pattern 115a and a space A2 between the previous gate line and the second shield pattern 115b are required. The gate line for being defined an upper pixel region P may be referred to as the previous gate line.

A TFT Tr, which is connected to the gate and data lines 105 and 130, as a switching element is disposed in the pixel region P. The TFT Tr includes a gate electrode 112, a gate insulating layer (not shown), a semiconductor layer 122, a source electrode 133 and a drain electrode 136. The gate electrode 112 is connected to the gate line 105, and the gate insulating layer is disposed on the gate electrode 112. The semiconductor layer 122 includes an active layer (not shown) of intrinsic amorphous silicon and ah ohmic contact layer (not shown) of impurity-doped amorphous silicon. The source electrode 133 is connected to the data line 130 and is spaced apart from the drain electrode 136. To maximize a channel length, the source electrode 133 has a “C” shape. However, there is no limitation in a shape of the source electrode 133.

A passivation layer (not shown) covers the TFT Tr. The passivation layer includes a drain contact hole 143 exposing the drain electrode 136 of the TFT Tr. A pixel electrode 150 is disposed in the pixel region P and on the passivation layer. The pixel electrode 150 contacts the drain electrode 136 through the drain contact hole 143.

A lower portion of the pixel electrode 150 overlaps the common line 108 to form a first storage capacitor StgC1. One side portion of the pixel electrode 150 overlaps the first shield pattern 115a to form a second storage capacitor StgC2. The other side of the pixel electrode 150 overlaps the second shield pattern 115b to form a third storage capacitor StgC3. An upper portion of the pixel electrode 150 overlaps the previous gate line to form a fourth storage capacitor StgC4. Since there is four storage capacitors StgC1, StgC2, StgC3 and StgC4 in one pixel region P, the LCD device has sufficient storage capacitance.

In more detail, a portion of the common line 108 overlapping the lower portion of the pixel electrode 150 serves as a first storage electrode of the first storage capacitor StgC1, the lower portion of the pixel electrode 150 serves as a second storage electrode of the first storage capacitor StgC1, and the gate insulating layer and the passivation layer interposed between the first and second storage electrodes of the first storage capacitor StgC1 serves as a dielectric material layer. A portion of the first shield pattern 115a overlapping the one side portion of the pixel electrode 150 serves as a first storage electrode of the second storage capacitor StgC2, the one side portion of the pixel electrode 150 serves as a second storage electrode of the second storage capacitor StgC2, and the gate insulating layer and the passivation layer interposed between the first and second storage electrodes of the second storage capacitor StgC2 serves as a dielectric material layer.

A portion of the second shield pattern 115b overlapping the other side portion of the pixel electrode 150 serves as a first storage electrode of the third storage capacitor StgC3, the other side portion of the pixel electrode 150 serves as a second storage electrode of the third storage capacitor StgC3, and the gate insulating layer and the passivation layer interposed between the first and second storage electrodes of the third storage capacitor StgC3 serves as a dielectric material layer. A portion of the previous gate line overlapping the upper portion of the pixel electrode 150 serves as a first storage electrode of the fourth storage capacitor StgC4, the upper portion of the pixel electrode 150 serves as a second storage electrode of the fourth storage capacitor StgC4, and the gate insulating layer and the passivation layer interposed between the first and second storage electrodes of the fourth storage capacitor StgC4 serves as a dielectric material layer.

Each of the first and second shield patterns 115a and 115b corresponds to a portion or an entire of a space between the data line 130 and the pixel electrode 150 such that a light leakage through the space between the data line 130 and the pixel electrode 150 is blocked by the first and second shield patterns 115a and 115b. Accordingly, a width of a black matrix (not shown) for shielding a light leakage through the space the data line 130 and the pixel electrode 150 can be reduced such that aperture ratio is improved. FIG. 3 shows each of the first and second shield patterns 115a and 115b corresponds to a portion of a space between the data line 130 and the pixel electrode 150. Alternatively, each of the first and second shield patterns 115a and 115b may correspond to an entire of a space between the data line 130 and the pixel electrode 150. Namely, one side of each of the first and second shield patterns 115a overlaps the data line 130, and the other side of each of the first and second shield patterns 115a overlaps the pixel electrode 150. In addition, the first shield pattern 115a in one pixel region P may be combined as one body with the second shield pattern 115a in another pixel region P.

When the array substrate is attached with the color filter layer to obtain the LCD device, an alignment error is generated with a range of about 3 to 5 micrometers. It is greater than a patterning error has a range less than about 1 micrometer. Accordingly, when a light leakage through a space between the data line and the pixel electrode is shield by the black matrix, the black matrix overlaps the pixel electrode with a width of about 3 to 5 micrometers considering the alignment error.

However, in the present invention, since each of the first and second shield patterns 115a and 115b is formed by a patterning process, which has an error less than about 1 micrometer, to be spaced apart from the data line 130 and overlap the pixel electrode 150, a width of the black matrix can be reduced such that aperture ratio is increased. In addition, when each of the first and second shield patterns 115a and 115b completely shield the space between the data line 130 and the pixel electrode 150, the aperture ratio is further increased. Furthermore, since an overlapped area between the first shield pattern 115a and the pixel electrode 150 and between the second shield pattern 115b and the pixel electrode 150 is used as the second and third storage capacitors StgC2 and StgC3, the LCD device has improved storage capacitance without a decrease of the aperture ratio.

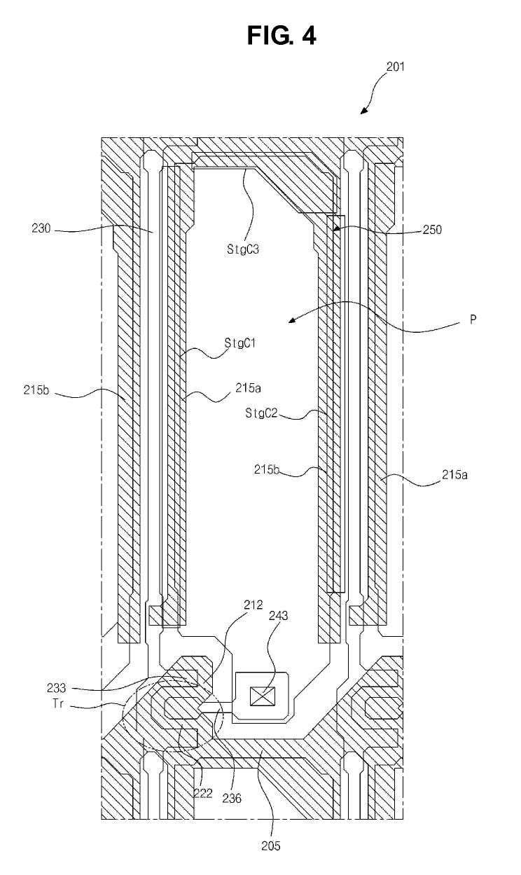

FIG. 4 is a plane view showing one pixel region of an array substrate for an LCD device according to a second embodiment of the present invention. The array substrate in the second embodiment has further improved aperture ratio without a decrease of the storage capacitance.

As shown in FIG. 4, a gate line 205 and a data line 230 are disposed on a substrate 201. The gate and data lines 205 and 230 cross each other to define a pixel region P.

First and second shield patterns 215a and 215b extend from the previous gate line at an upper portion of the pixel region P. With compared to the array substrate in the first embodiment, there is no common line 108 (of FIG. 3). Accordingly, a decrease of the aperture ratio by the common line 108 is prevented.

In addition, since each of the first and second shield patterns 215a and 215b extends from the previous gate line, a space A1 the previous gate line and the first shield pattern 115a and a space A2 between the previous gate line and the second shield pattern 115b in the array substrate of the first embodiment is not required. Namely, since an area of the space A1 the previous gate line and the first shield pattern 115a and the space A2 between the previous gate line and the second shield pattern 115b in the array substrate of the first embodiment is used for the storage capacitors, the storage capacitance is improved.

Each of the first and second shield patterns 215a and 215b should be spaced apart from the gate line 205 in the pixel region P to avoid an electrical short with the gate line 205. However, because the spaces between the first shield pattern 215a and the gate line 205 and between the second shield pattern 215b and the gate line 205 are occupied by the common line 108 (of FIG. 3) in the array substrate of the first embodiment and the common line 108 should be spaced apart from the gate line 105, there is no loss in an area.

FIG. 4 shows each of the first and second shield patterns 215a and 215b corresponds to a portion of a space between the data line 230 and the pixel electrode 250. Alternatively, each of the first and second shield patterns 215a and 215b may correspond to an entire of a space between the data line 230 and the pixel electrode 250. Namely, one side of each of the first and second shield patterns 215a overlaps the data line 230, and the other side of each of the first and second shield patterns 215a overlaps the pixel electrode 250. In addition, the first shield pattern 215a in one pixel region P may be combined as one body with the second shield pattern 215a in another pixel region P.

A TFT Tr, which is connected to the gate and data lines 205 and 230, as a switching element is disposed in the pixel region P. The TFT Tr includes a gate electrode 212, a gate insulating layer (not shown), a semiconductor layer 222, a source electrode 233 and a drain electrode 236. The gate electrode 212 is connected to the gate line 205, and the gate insulating layer is disposed on the gate electrode 212. The semiconductor layer 222 includes an active layer (not shown) of intrinsic amorphous silicon and ah ohmic contact layer (not shown) of impurity-doped amorphous silicon. The source electrode 233 is connected to the data line 230 and is spaced apart from the drain electrode 236. To maximize a channel length, the source electrode 233 has a “C” shape. However, there is no limitation in a shape of the source electrode 233.

A passivation layer (not shown) covers the TFT Tr. The passivation layer includes a drain contact hole 243 exposing the drain electrode 236 of the TFT Tr. A pixel electrode 250 is disposed in the pixel region P and on the passivation layer. The pixel electrode 250 contacts the drain electrode 236 through the drain contact hole 243.

One side portion of the pixel electrode 250 overlaps the first shield pattern 215a to form a first storage capacitor StgC1. The other side of the pixel electrode 250 overlaps the second shield pattern 215b to form a second storage capacitor StgC2. An upper portion of the pixel electrode 250 overlaps the previous gate line to form a third storage capacitor StgC3. Since there is three storage capacitors StgC1, StgC2 and StgC3 in one pixel region P, the LCD device has sufficient storage capacitance.

In more detail, a portion of the first shield pattern 215a overlapping the one side portion of the pixel electrode 250 serves as a first storage electrode of the first storage capacitor StgC1, the one side portion of the pixel electrode 250 serves as a second storage electrode of the first storage capacitor StgC1, and the gate insulating layer and the passivation layer interposed between the first and second storage electrodes of the first storage capacitor StgC1 serves as a dielectric material layer. A portion of the second shield pattern 215b overlapping the other side portion of the pixel electrode 250 serves as a first storage electrode of the second storage capacitor StgC2, the other side portion of the pixel electrode 250 serves as a second storage electrode of the second storage capacitor StgC2, and the gate insulating layer and the passivation layer interposed between the first and second storage electrodes of the second storage capacitor StgC2 serves as a dielectric material layer. A portion of the previous gate line overlapping the upper portion of the pixel electrode 250 serves as a first storage electrode of the third storage capacitor StgC3, the upper portion of the pixel electrode 250 serves as a second storage electrode of the third storage capacitor StgC3, and the gate insulating layer and the passivation layer interposed between the first and second storage electrodes of the third h storage capacitor StgC3 serves as a dielectric material layer.

There are fourth storage capacitors in the array substrate of the first embodiment, while there are three storage capacitors in the array substrate of the second embodiment. In more detail, there is no storage capacitor formed by the common line 108 (of FIG. 3) and the pixel electrode 150 (of FIG. 3) in the array substrate of the second embodiment. However, since each of the first and second shield patterns 215a and 215b extends from the previous gate line, the spaces A1 and A2 (of FIG. 3) between the first shield pattern 115a (of FIG. 3) and the previous gate line and between the second shield pattern 115b (of FIG. 3) and the previous gate line are not required. Accordingly, the first and second shield patterns 215a and 215b in the spaces A1 and A2 (of FIG. 3) are used for the first and second storage capacitors StgC1 and StgC2, respectively, such that the array substrate of the second embodiment has substantially the same storage capacitance as the array substrate of the first embodiment.

On the other hand, since there is no common line in the array substrate of the second embodiment, the aperture ratio of the array substrate in the second embodiment is increased. By the simulation, with compared to the first embodiment, the array substrate of the second embodiment has improved aperture ratio of about 2.14% by deleting the common line.

In the present invention, since there are three or four storage capacitors, the array substrate has sufficient storage capacitance. In addition, since the first and second shield patterns shield a space between the data line and the pixel electrode, the array substrate has improved aperture ratio. Furthermore, since there is no common line in the array substrate of the second embodiment, the array substrate has further improved aperture ratio.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. An array substrate for a liquid crystal display device, comprising:
a plurality of gate lines on a substrate;
a plurality of data lines crossing the plurality of gate lines to define a plurality of pixel regions;
a thin film transistor connected to one of the plurality of gate lines and one of the plurality of data lines and disposed in one pixel region of the plurality of pixel regions;
first and second shield patterns respectively extending from a previous gate line of the plurality of gate lines to the one pixel region, the first shield pattern disposed at one side of the one pixel region, and the second shield pattern disposed at the other side of the one pixel region; and
a pixel electrode in the one pixel region and over the thin film transistor, the pixel electrode overlapping the first and second shield patterns and the previous gate line.

2. The array substrate according to claim 1, wherein each of the first and second shield patterns is spaced apart from the one of the plurality of gate lines.

3. The array substrate according to claim 1, wherein the first shield pattern shields a space between the one of the plurality of data lines and the pixel electrode, and the second shield pattern shields a space between another one of the plurality of data lines and the pixel electrode.

4. The array substrate according to claim 3, wherein the first shield pattern overlaps the one of the plurality of data lines such that the space between the one of the plurality of data lines and the pixel electrode is completely shielded by the first shield pattern.

5. The array substrate according to claim 3, wherein the second shield pattern overlaps the another one of the plurality of data lines such that the space between the another one of the plurality of data lines and the pixel electrode is completely shielded by the first shield pattern.

6. The array substrate according to claim 1, wherein the overlapped portion of the first shield pattern and the pixel electrode constitutes a first storage capacitor, and the overlapped portion of the second shield pattern and the pixel electrode constitutes a second storage capacitor, and wherein the overlapped portion of the previous gate line and the pixel electrode constitutes a third storage capacitor.

7. The array substrate according to claim 1, wherein the thin film transistor includes a gate line connected to the one of the plurality of gate lines, a semiconductor layer over the gate electrode, a source electrode on the semiconductor layer and connected to the one of the data lines, and a drain electrode on the semiconductor layer and spaced apart from the source electrode.

8. The array substrate according to claim 7, further comprising a passivation layer covering the thin film transistor and including a drain contact hole exposing the drain electrode.

9. The array substrate according to claim 8, wherein the pixel electrode is disposed on the passivation layer and contacts the drain electrode through the drain contact hole.

10. The array substrate according to claim 7, wherein the source electrode has a “C” shape.

11. The array substrate according to claim 1, wherein the first shield pattern in the one pixel region is combined with the second shield pattern in another pixel region as one body such that a space between the one data line and the pixel electrode is completely shielded.
